(19) United States
(12) Patent Application Publication
(10) Pub. No.: US 2011/0297120 A1
(43) Pub. Date: Dec. 8, 2011

(54) RAKH Cycle, Boilerless, Airless, Hydrogen Fueled, Closed Cycle, Steam Engine

(76) Inventor: Robert David HURT, San Diego, CA (US)

(21) Appl. No.: 12/794,729

(22) Filed: Jun. 5, 2010

(51) Int. Cl. F02B 43/10; F02M 25/07; F02B 51/02

(52) U.S. Cl. 123/25 A; 123/568.11

(57) ABSTRACT

This engine inducts Hydrogen and an inert Quench gas into its combustion chamber, compresses the mixture, and injects Hydrogen Peroxide thru catalytic injectors to burn the Hydrogen in the dissociated oxygen that is liberated. Exhaust flows into a Gas Drier/Condenser (GD/C), which removes exhaust steam. Non-condensable gasses are returned to the engine intake in a closed loop where hydrogen is continuously added via a constant pressure regulator to replace burned Hydrogen. Presence of the Quench gas in the mixture effectively reduces total hydrogen available for combustion. This engine could not work as a closed cycle without the GD/C, which contains a pressurized water trap that allows free flow of recycled non-condensable gasses thru that trap, but condenses steam as it passes thru one ceramic plate and comes into direct contact with pressurized water trapped between the ceramic plates. The pressurized water trap separates the GD/C's inlet from its outlet.

### BACKGROUND OF THE INVENTION

Steam engines have proven to be more efficient than modern Internal Combustion Engines, however, size, weight, and safety hazards, underscore some major disadvantages for typical boiler driven steam engines. Steam engines also suffer cost disadvantages stemming from the use of expensive alloys involved in boiler and condenser construction. Continuous degradation of heat transfer efficiency caused by water born impurities or combustion products being deposited on heat exchange surfaces also plague the typical steam engine. They also typically have a flue or smoke stack that contributes to efficiency losses.

The present invention, which I designate the RAKH Cycle Engine, amplifies the efficiency advantages of a typical steam engine while eliminating all of its disadvantages. The RAKH Cycle Engine creates steam through direct contact of water with the combustion product of Hydrogen and Oxygen. That is superheated steam. The direct production of superheated steam inside the combustion chamber eliminates frictional piping losses involved with transporting steam into the engine as well as eliminating the boiler and its associated heat transfer surfaces. Without a boiler, there can be no boiler explosions. We get a much smaller and safer engine. The direct contact of combustion products with water injected into the combustion chamber means there are no expensive heat exchanger conductive surfaces to maintain or even purchase in the first place. Also, no polluting and efficiency-robbing, hot, noxious, flue gasses are released into the environment. Hydrogen Peroxide decomposes rapidly into water and oxygen in the presence of a catalyst. This catalytic reaction is highly exothermic, meaning, it produces heat. Converting hydrogen peroxide to water and oxygen in an exothermic reaction in the presence of a catalyst to create hot gases has been understood and used for quite some time. During World War II German V-2 rocket utilized Hydrogen Peroxide to run a turbine. A land speed record was set by a vehicle using only Hydrogen Peroxide with a metallic catalyst to create high temperature, high pressure steam and oxygen, as a pure thrust driven rocket, to propel the vehicle to a speed of several hundred miles per hour. Taking good advantage of the prodigious quantity of pure Oxygen that is released can only further enhances the value of Hydrogen Peroxide. Oxidizing a fuel with the excess oxygen causes a second highly exothermic reaction. More heat is released! When the fuel is pure Hydrogen, the only combustion product is superheated steam.

Engines using Hydrogen Peroxide have been around for decades. Hydrogen combustion engines have been used even longer. I have found no piston engines however, which intake hydrogen rather than air (other than by forced injection), which also inject liquid peroxide directly into the combustion chamber to liberate water, steam, and oxygen, which supports internal combustion, all operating within a closed cycle. I found two U.S. patents issued for closed cycle engines that use the oxygen from peroxide to burn hydrocarbons, which either required chemicals to remove the carbon dioxide (U.S. Pat. No. 3,658,043 & U.S. Pat. No. 3,077,737) or operate only temporarily. One patent had hydrogen peroxide injected into a pre-chamber to cool it before allowing it to enter a combustion chamber, losing advantage of the exothermic heat of dissociation to create steam (U.S. Pat. No. 2,915,030). One closed cycle engine patent operates with an expanding waste chamber to accommodate the buildup of waste products (U.S. Pat. No. 2,915,030) and one just compressed the waste gas (U.S. Pat. No. 2,325,619).

Some engines inventors did recognize the problem of excessive heat when no inert Quench gas is present, so they added it, but could not effectively and inexpensively deal with the problem it created in a resulting gas bound condenser. The present invention has found an efficient solution for an internal combustion operating within a closed loop where an inert quench gas is added.

The novel Gas Drier/Condenser (GD/C) of the present invention has a gross advantage over most types of condensers by not becoming gas bound from non-condensable gas build-up. The GD/C is simple, cheap, light weight, and highly effective at removing the engine's one product of combustion (steam), while passing all non-condensable gasses right back to the intake of the engine, without significant backpressure. Gas binding is prevented in most condensers by steam powered air ejectors or motor driven “hogging” pumps, which remove non-condensable gasses along with some steam losses to the atmosphere. In the GD/C, condensation occurs by direct contact with cooling water rather than relying on extensive and usually expensive alloy tubing in the condenser. Direct contact of steam with cooling water in this condenser means less weight and less surface conduction efficiency loss.

Hydrogen and Hydrogen Peroxide are both synthetic products, not harvested raw materials like wood, coal, oil or natural gas. Gasoline has become the fuel of choice because it is a highly compact, portable fuel. However, gasoline comes from oil and America imports over 50% of its oil. Our economic health requires a reasonable substitute, which the public can justify. A Hydrogen economy has been supported by the government and is being touted as our best near term solution. The RAKH Cycle Engine is proposed as the most economic way to embrace that up and coming hydrogen economy.

The obvious question should be; why would people drive a car requiring Hydrogen Peroxide if they could run an air-breathing and Hydrogen burning Internal Combustion Engine (ICE) with its typical 20% efficiency? To try answering this, let us assume gasoline costs $6 per gallon in a few years and you can get 30 mpg in a typical gasoline powered car. It would cost you $30 to run that car 150 miles getting 30 mpg. A gallon of gas has roughly the same energy as just one kilogram of Hydrogen, so we should expect that a 20% efficient engine could get about 30 miles per gallon of gas or 30 miles per kilogram of Hydrogen. If Hydrogen costs $6 per kilogram, then it would also cost $30 for the 150 mile trip. Now let us assume a RAKH Cycle Engine can reach 40% efficiency using peroxide. The RAKH Cycle Engine would only burn 2.5 kilograms of hydrogen for the same 150 mile trip, while consuming about 14.5 gallons of 50% concentrate Hydrogen Peroxide (just assume these figures are correct now, for the sake of discussion). If 50% concentrate Hydrogen Peroxide could be purchased for only $1 per gallon, it would cost $14.50 for the Hydrogen Peroxide that the RAKH Cycle Engine would use and $15 for the 2.5 Kg of Hydrogen it would use, for a lower total cost of $29.50. You'd save a few cents. But, a much smaller Hydrogen gas tank would be required for the engine operating at 40% efficiency given the same mileage range expectation. There would be a significant size advantage for the more efficient RAKH Engine car over the same distance. This argument depends, however, on having a 40% efficient RAKH Cycle Engine. An efficiency of 40% is on the high side of what is typical these days for a closed cycle steam engine. Closed cycle steam engines already push this level of efficiency! RAKH Cycle Engines would have several previously mentioned advantages over typical closed cycle steam engines operating at the same temperatures. High steam temperatures inherent with a RAKH Cycle Engine yield a high theoretical Carnot thermodynamic efficiency. RAKH Cycle Engines can create and use steam at temperatures and pressures that are above the critical temperature and pressure for steam. This is not practical for most closed cycle steam engines. This present invention also lends itself well to the attachment of a bottoming heat engine, because of the high exhaust temperature that it produces.

If the U.S. does convert to a Hydrogen based economy, there will be a push for cars that can cover distances close to the cruising ranges of the gasoline powered models that they have grown used to driving without the penalty of carrying huge Hydrogen tanks. An efficient, compact, non-polluting engine, such as the RAKH Cycle Engine, would be an attractive draw for both consumers and the Environmental Agencies. Use of the RAKH Cycle Engine as a stationary motor generator for emergency power may be the first step however, since that required infrastructure is not yet here. Small and efficient, quick starting stationary steam engine based generators without boilers or exhaust pipes are needed right now! Combining the present invention with hot water heaters or swimming pool heaters would be an extremely attractive arrangement.

### BRIEF DESCRIPTION OF THE DRAWINGS

FIG. 1 Illustrates a simplified schematic of pertinent components of a RAKH Cycle Engine.

This Figure is conceptual, showing the relationship of the various components of the engine without regard for relative scale sizes of those components. The Gas Drier/Condenser (GD/C) is in actuality of necessity, much larger than the engine for instance.

FIG. 2 Illustrates the Injector Body Drawing.

The Injector Body shows that there are four main parts to the Hydrogen Peroxide Injector. The injector body has a top and bottom that screw together. The top part holds in a check valve, which prevents the back flow of combustion chamber gasses after a pulse of Hydrogen Peroxide is admitted past the check valve. A Catalytic cartridge is screwed into the bottom of the injector, through the elliptical injector nozzle opening. The metal catalyst surrounds the cartridge and will not contact the injected peroxide until it is forced out of the many holes that are drilled into the screw-in cartridge. There are no specific claims made in this patent with regard to the injectors. The injector are different than normal diesel or other direct injectors since they must both inject and dissociate the peroxide into steam and oxygen and have a provision for cooling the nozzle with plain water.

FIG. 3 Illustrates the Upper Injector Body Detail

FIG. 4 Illustrates the Lower Injector Body Detail.

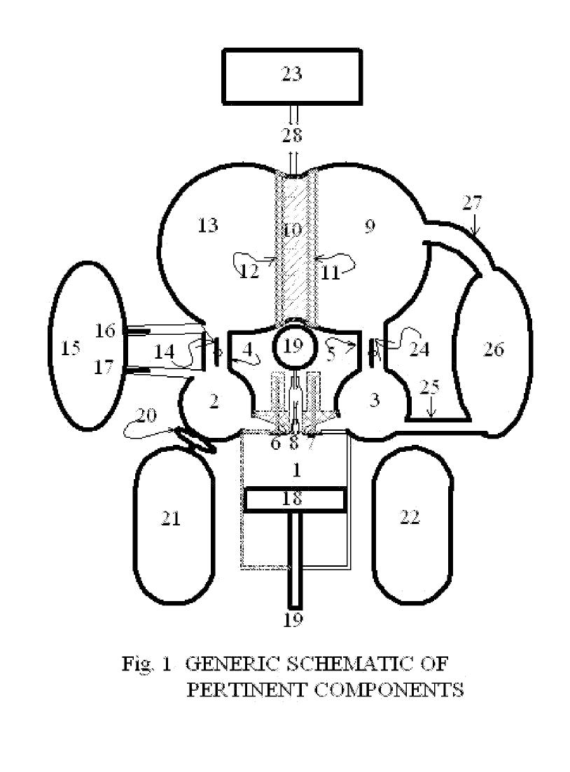

FIG. 1 GENERIC SCHEMATIC OF PERTINENT RAKH CYCLE ENGINE COMPONENTS

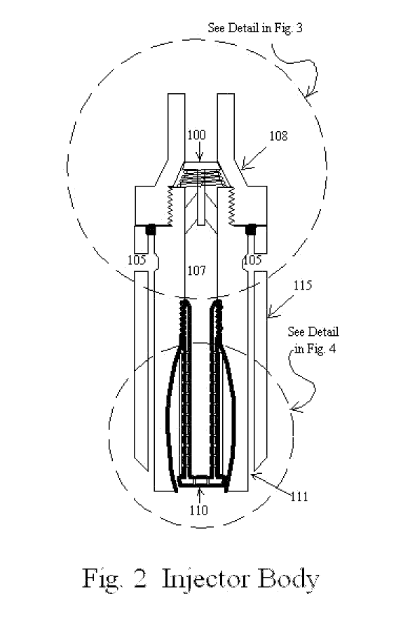

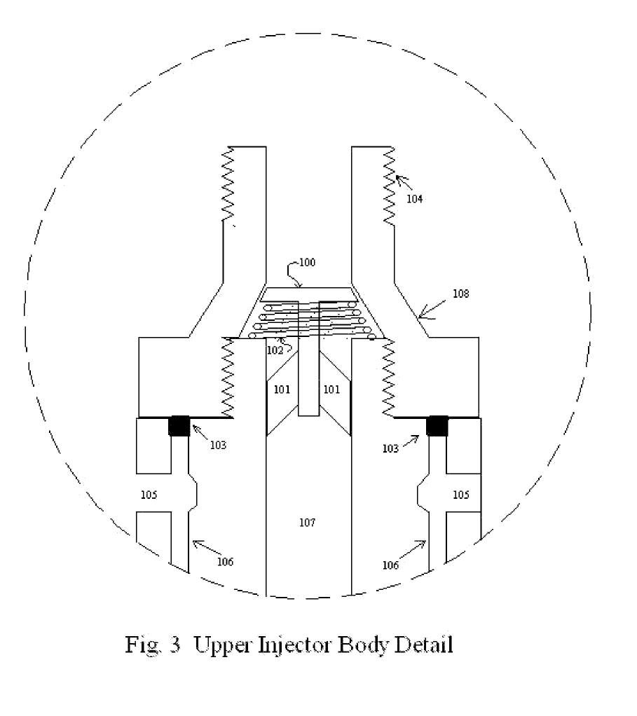

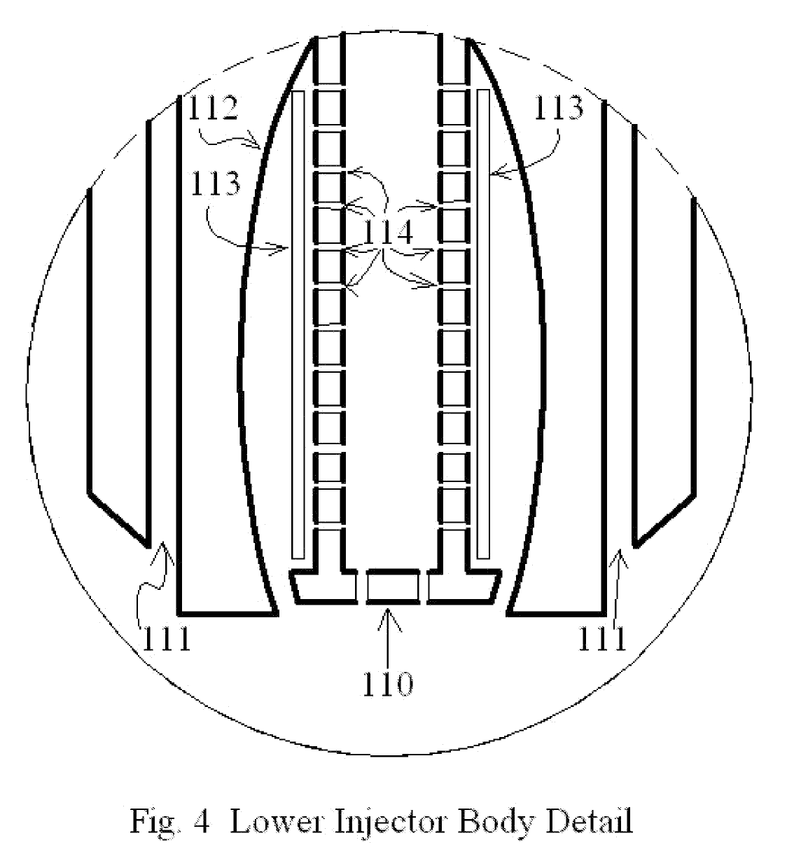

FIG. 2 DETAILED INJECTOR DRAWING

FIG. 3 UPPER INJECTOR BODY DETAIL

FIG. 4 LOWER INJECTOR BODY DETAIL

### DETAILED DESCRIPTION OF THE PREFERRED EMBODIMENT

FIG. 1 illustrates a simplified schematic of the preferred embodiment of the present invention as a piston and cylinder type engine. Piston 18 is connected to a typical crankshaft (not shown) by a connecting rod 19 in a typical piston engine arrangement that converts oscillating motion to rotary mechanical energy that performs the output work of the RAKH engine. The crankshaft also returns some of the rotary mechanical energy thru the connecting rod 19 to suck in a charge of fuel and subsequently compress that intake charge. This detailed description assumes as an arbitrary starting point, the intake of Hydrogen and Helium from the intake manifold 2 thru intake valve 6 into the combustion chamber 1. The Helium is circulated thru the closed system loop, and is never lost from the closed loop system. The pressure of the Helium is fairly constant unless it is pumped out of the system into the Quench gas storage tank 15, which operation will not be described until later, but that Quench gas storage tank is normally isolated from the closed loop system by closed valves 16 and 17. Hydrogen is consumed in the engine and is constantly added to the intake manifold 2 from Hydrogen supply tank 21 via a variable pressure regulator 20, which maintains the intake manifold pressure at whatever pressure setting is established by an engine control module (not shown). For the sake of an initial condition setting, let us assume that the partial pressure of the Helium in the intake manifold 2 is 10 psia, and the regulator 20 is initially set to 15 psia. The regulator 20 attempts to provide 5 psia of hydrogen to the intake manifold 2, for an overall pressure of 15 psia. The Piston 18 draws in a charge of the pressurized mixture from the intake manifold 2 when the piston 18 is pulled down the cylinder with the intake valve 6 opened and the exhaust valves 7 closed by the engine control module in response to a timing signal derived from the position of the crankshaft and the engine's load requirements. Near the bottom of the intake stroke, while the engine is operating in four stroke power mode, the intake 6 and all exhaust 7 valves are both closed near the point where the crankshaft begins to force the piston 18 up via connecting rod 19 and compress the hydrogen and helium with a full intake charge in the combustion chamber 1. Near top dead center, with intake and exhaust valves still closed, a throttled pulse of Hydrogen Peroxide, under control of an engine control module (typically a computerized electronic control module not subject to any claims in this patent), is squirted into the injector nozzle 8 where a catalyst 113 starts the release of available Oxygen from the Hydrogen Peroxide. Both volume and timing are variables that will be adjusted by that engine control module, according to the current load requirements. The Oxygen released from the Hydrogen Peroxide, burns the Hydrogen, as much as it can. The combustion of the hydrogen creates superheated steam. The exothermic release of Oxygen creates heat and steam also. The superheated steam created from the combustion of Hydrogen in oxygen and the excess heat will help convert any remaining water from the diluted Hydrogen Peroxide into steam also. There will be Pressure exerted upon the piston 18 by the steam, which forces the piston 18 down in a power stroke that recovers significantly more energy than the amount consumed in first inducting and then compressing the Hydrogen and Helium. There will be enough mechanical energy created and partially stored in a flywheel (also not shown) connected to the crankshaft to carry the piston past bottom dead center and cause the piston to travel back up the cylinder with one or two exhaust valves 7 opened by the electronic control module to force the exhaust out of the combustion chamber 1 and into the exhaust manifold. At the end of the exhaust stroke, the exhaust valve(s) will be closed and the intake stroke can start all over again in a continuing 4 stroke cycle at moderate engine loads. Alternatively, as the temperature of the combustion chamber increases all valves can be closed by the engine control module near the end of the exhaust stroke, and a squirt of water thru the outer injector water passages 111 will be admitted to cool the combustion chamber as the heat of the cylinder and piston flashes the water into steam with another power stroke and exhaust stroke inserted to cool the engine as needed. Materials used in the preferred embodiment of the cylinder block of this engine would be ceramic or tungsten, able to withstand relatively higher temperatures than most piston engines without permanent deformation from overheating. It is highly desirable to run this engine without cooling water in a water jacket that is cast into the engine block.

Exhaust travels from the exhaust manifold 3 thru the exhaust duct 5 into a Gas Drier/Condenser (GD/C) inlet 9. The pressure differential of exhaust gasses entering the GD/C inlet 9 and being evacuated from the GD/C outlet 13 by the intake pumping action of the engine drawing a vacuum on the intake manifold with the throttle butterfly valve 14 open, allows communication of that vacuum to the GD/C outlet 13 via the inlet duct 4, causing non-condensable exhaust gasses to pass thru the two low restriction ceramic plates 11 and 12, and the pressurized water 10 trapped between those plates. Steam and Non-condensable Gasses freely pass thru the trap, but the water cannot escape. When steam hits relatively cool trap water that is maintained well below the saturation temperature for the existing exhausted steam pressure, it will condense immediately, imparting latent heat of vaporization into the water 10. Helium and any remaining Hydrogen, present in the exhaust, will see very little restriction in their flow posed by the porous ceramic 11 & 12 and water 10, which comprise the water trap. It is true that some vapor pressure of the hot trap water 10 will escape thru the outlet side ceramic plate 12 and the outlet gasses will not be perfectly dry. The cooler the trap water is, the dryer the Condenser outlet gasses will be. The preferred embodiment will use expansion of compressed Hydrogen to help cool the water used in the water trap. An ammonia bottoming cycle would be desirable to power accessories. When the engine control module detects a net drain on batteries, the power can be increased by closing the intake duct throttle butterfly valve 14 and opening the Quench gas storage tank's inlet valve 16. The tank will pressurize with non-condensable gasses that exit the GD/C outlet 13. If the Quench Gas storage tank 15 is about the same size as the GD/C, about half of the non-condensable gasses, mostly Helium, should exit the closed loop system. After gas flow into the Quench Gas storage tank subsides, the partial pressure of Helium in the closed loop system should be about half of the initial value (about 5 psia), within only a few seconds. The Hydrogen regulator should make up the difference in pressure from 15 psia by admitting Hydrogen to 10 psia. The Quench Gas storage tank inlet valve 16 can then be closed and the intake duct butterfly valve 14 can be reopened. The partial pressure of the Helium will continue at about 5 psia until the high power (“turbo mode”) is no longer needed. At that point of reduced power needs, the butterfly valve can be closed again at the same time the Quench tank outlet valve 17 is opened, sucking Helium back into the closed loop and nearly emptying the Quench gas storage tank 15. The partial pressure of Helium will once again return to approximately 10 psia, and the Hydrogen regulator 20 will reduce the supply of Hydrogen to the system to a partial pressure of about 5 psia. The electronic control module will initially “dead reckon” the maximum amount of Hydrogen Peroxide that can be injected so that no excess oxygen is produced in the combustion chamber, which might otherwise make it into the exhaust without enough Hydrogen in the combustion chamber to use up all of the oxygen. After the initial “dead reckoning” guess at the maximum amount of Hydrogen Peroxide that should be injected for maximum power, Oxygen Sensors in the exhaust path or in the water trap can be used to reduce the maximum Hydrogen Peroxide injection amount. Increasing the amount of hydrogen in the combustion chamber is very much like the effect of turbo charging an engine, without the significant increase in backpressure on the exhaust system incumbent with turbo charging. The net result of both is to increase the amount of fuel that can be burned inside the combustion chamber. The simplicity of the described “turbo charging” effect in the RAKH Cycle Engine is quite evidently much easier and certainly less mechanically burdensome. The technique of changing the 4 stroke operation of the RAKH Cycle Engine to 2 stroke operation should be simple enough for any reasonably proficient automotive engineer to discern that I will not bore the reader with those details, understanding that the engine control module manipulates the valves and injectors appropriately. A crankcase vent tube (not shown), which simply vents the cylinder at a point below the piston and leads to the exhaust side of the closed loop, adds no challenge to the system. The fact that blow-by is not toxic or burdensome to the RAKH Cycle Engine, allows us to consider omitting the rings in the preferred embodiment since the preferred implementation of this engine is to run it only at a fairly constant high operating speed after startup or shut it off when batteries are sufficiently charged. The engine is either off or it is running at high operating speed, typically 1800 rpm for a four pole 60 Hz AC generator. Engines without rings don't usually idle very well.

The Hydrogen Peroxide storage tank 22 can contain high concentration Hydrogen Peroxide that is mixed with water derived from a Radiator 23 via a Pump/Mixer 19. A considerable amount of heat must be removed from the water trap by the Radiator 23. The tubes delivering water from the Radiator and those from the Hydrogen Peroxide tank 22 to the Injector Pump/Mixer 19 are not shown in the schematic, but the Radiator Inlet Tube 28 allows outflow of water from the Water Trap 10 to the Radiator 23. There may be no coolant for the RAKH Cycle Engine. The Upper Cylinder Walls and Head can be made of Tungsten metal. When the temperature exceeds a certain limit, the Engine Control Module will manipulate valve operation to insert occasional 6 cycle engine cooling operation via direct injection of water immediately after the exhaust stroke. This Water injection creates low temperature steam from the heat of the cylinder walls, which expands doing work with another power stroke, followed by another exhaust stroke.

FIG. 2 shows details of the Injector 8. All reference numbers are three digit numbers, except the Injector itself which is still given reference number 8 in both FIG. 1 and FIG. 2. The water jacket bleed orifices 105 and 102, continuously leak a very small amount of water from the water trap to keep the injector cooled and can be pulsed to spray directly onto the upper cylinder walls via an Anti-Bypass Valve (not shown) that closes and inhibits pulse bypass at Top Dead Center for on any given stroke. Pulses are normally bypassed unless the Anti-Bypass valve is closed by the Engine Control Module using input from an over-temperature sensor. Cooling water can be added at Top Dead Center on any stroke, but results in wasted efficiency if it is injected on the Intake Stroke during 4 stroke, or 6 stroke operation of the RAKH Cycle Engine. Extra water injected for the power stroke in 4 stroke operation can also cool the cylinder somewhat. Even more cooling results however, if the water is injected near top dead center after the exhaust valve closes and a secondary power stroke and exhaust stroke are added, totaling 6 strokes. Although the secondary power stroke occurs at a much lower temperature, because there is no combustion involved, and very little high pressure gas is left in the cylinder when the water that is squirted into the combustion chamber converts to steam, it adds to the efficiency of the RAKH Cycle Engine by direct cooling of the cylinders thru latent heat of vaporization of water and the resultant steam is used for a small increment of extra power without needing more fuel. Most internal combustion engines waste this heat by external water jackets and a radiator. The high temperature exhaust from four stroke operation should be used in an optional bottoming engine 26 with exhaust ducted to the intake via bottoming intake duct 25 and then exhausted at a much less energetic pressure and temperature state via bottoming exhaust duct 27 into the GD/C. The bottoming engine can be bypassed or forced into operation by opening or closing the butterfly valve 24 in the RAKH Cycle Engine exhaust duct 5.

The Injector Upper Body Detail in FIG. 3 shows a one way valve 100 which lets Hydrogen Peroxide in but seals against reverse flow after the pump pulse terminates. The one way valve has a coil return spring 102, which seats the valve and centering fins 101 that keep the valve positioned properly. Some Peroxide is held inside the injector body within its inert, non-catalytic, chamber 107. Cooling water is allowed to dribble into the injector thru injector water inlet holes 105 drilled around the circumference of the injector as needed. They intersect injector cooling water passage ways 111 drilled vertically, nearly the full length of the injector body, opening into the combustion chamber with the opposite end plugged. The injector head 108 screws onto the injector body 115 and both traps the hydrogen peroxide anti reverse flow check valve 100 and provides a seat for it. Stainless Steel compression fittings (not shown) attach to the threaded top of the injector head 104 which connects to the injector Pump/Mixer housing 19. The injector head 108 also retains the injector water plugs 103 at the top of the injector cooling water passage ways 111.

The Engine described here may be substantial varied. While an optional embodiment of this application as a piston and cylinder engine has been described, it should be evident to those skilled in the art that many inconsequential modifications are possible without departing from the inventive concepts revealed herein. This engine can use much smaller valves than air breathing engines since Hydrogen and Helium have much lower resistance to flow. Whole valve and seat assemblies could be screwed into the head, eliminating the need for a separate head and block assembly with a head gasket and head bolts. Solenoid operated valves also won't require a cam.

What I claim is:

1. a boilerless, closed-cycle, steam engine, wherein Hydrogen is inducted together with an optional added inert Quench gas, to create a combustible atmosphere directly within the said engine's combustion chamber, whereupon hydrogen combines with freed oxygen that is derived from hydrogen peroxide being injected through a catalytic nozzle that dissociates it into steam and oxygen upon its injection into said engine, producing superheated steam as a high pressure, high temperature working fluid directly inside its combustion chamber from the combined heats of:
a) Adiabatic heating of the intake gasses via mechanical compression;
b) Exothermic heat of dissociation of water and oxygen from hydrogen peroxide that is injected into the combustion chamber through a catalytic nozzle, and;
c) Combustion of a part of the inducted Hydrogen with all said dissociated Oxygen;
whereby the said superheated steam and residual induction gasses produce work by impulse or adiabatic expansion, on mechanical components that are commonly used in other, typical steam engines.

2. a segmented Gas Drier/Condenser (GD/C), having an exhaust gas inlet and a dry gas outlet, divided from each other by a pressurized, water trap, having gas permeable, water containment plates that freely allow steam along with non-condensable gasses to pass into the said water trap through the GD/C inlet side, water containment plate, but which effectively passes only non-condensing gasses out of the trap's GD/C outlet side, water containment plate, allowing it to be operated continuously in a closed loop with the said engine of claim 1 acting as the exhaust gas flow pump in the course of its normal intake and exhaust process, forcing removal of the steam via said water trap, without the GD/C binding on a build-up of non-condensable gasses, as would a conventional condenser;

3. a Loop Inert Gas Storage (LIGS) Tank, having valve controlled inlet and outlets, respectively that are ducted across a blockable bypass point in the closed loop; typically from the GD/C outlet described in claim 2 into the LIGS Tank, and out of the LIGS tank to the Intake Manifold of the engine of claim 1, whereby the valves may be operated in concert with a loop shutoff valve, placed between those two LIGS Tank ducts in the closed loop, so as to allow temporary blockage of the closed loop; either allowing gas into the LIGS tank thru its inlet valve for the purpose of removing Quench gas from the closed loop, or alternately, allowing inert Quench gas to re-enter the closed loop when the LIGS outlet valve is opened and its inlet valve is closed, in order to effectively vary the percentage of Hydrogen available in a fairly constant pressure intake atmosphere and thereby control combustion temperature and available fuel as a power trimming and throttling adjustment device for the engine of claim 1.
